(19) United States
(12) Patent Application Publication
(10) Pub. No.: US 2005/0135659 A1
(43) Pub. Date: Jun. 23, 2005

(54) Optical motion sensor

(76) Inventor: John Davidson Smith, Richmond, VA (US)

Correspondence Address: JOHN H. THOMAS, P.C., 1561 EAST MAIN STREET, RICHMOND, VA, 23219, US

(21) Appl. No.: 10/742,044

(22) Filed: Dec. 19, 2003

(51) Int. Cl. G06K 9/00

(52) U.S. Cl. 382/107; 382/103

(57) ABSTRACT

An optical device senses the motion or lack of motion of a moving surface that is perpendicular to the axis of the device. The sensor obtains images of the movable surface, and then analyses those images to determine the nature of the motion. The sensor then produces output signals indicating the state of motion of the movable surface. The optical device does not require contact with the surface of motion or a separate lighting source or a target applied to the movable surface. The optical sensor includes a lens assembly, a light source, an image processing unit, and a motion evaluation unit to accomplish the sensing of the movement of the surface.

The field of the present invention is motion sensors. Specifically the present motion sensor is a non-contacting, single-ended and targetless optical motion sensor.

### BACKGROUND

The many applications for motion sensors and their usefulness in industry are well known. Particularly in manufacturing industries, the use of motion sensors is broad.

Many sensors are commercially available for measuring presence, distance, rotation, and velocity; however, these existing devices have various shortcomings. Also, if the application is a simple motion/no motion sensing of a conveyor belt, for instance, then many prior systems are complicated and more technology than is necessary. Different categories of systems that are known in the industry include the following: optical incremental encoders, interrupters, photo-reflective sensors, proximity and Hall-effect switches, laser interferometers, triangulation sensors, magnito-restrictive sensors, ultra sonic detectors, cable extension transducers, LVDT sensors, and tachometers. Each of the foregoing sensor systems has various shortcomings. Those shortcomings include that many systems require connection of a sensor to a moving or rotating part. Many systems require a target to be attached to or embedded on a moving or rotating part. Some systems require a through-beam, thereby compelling a multi-ended system. Many of the systems that are not directly connected to a moving or rotating part nevertheless require close proximity to some form of target or some degree of contact with a moving part.

### SUMMARY

Accordingly, it is an object of the present invention to overcome the foregoing drawbacks and provide a non-contacting, single-ended and targetless optical motion sensor.

In one example, an optical system for sensing the motion of a movable surface may comprise or it may consist essentially of a lens assembly, a light source, an image processing unit and a motion evaluation unit. The lens assembly is adapted to magnify an image of a movable surface. The image processing unit is adapted to obtain images of the movable surface and convert those images into motion data, with the image processing unit placed on the opposite side of the lens from the movable surface. The motion evaluation unit is electronically connected to the image processing unit and is adapted to evaluate the motion data obtained from the image processing unit. The system does not contact the movable surface. In one example, the optical system described above may be mounted within a single, integral housing. The image processing unit may comprise photoreceptors connected to an image processor. The lens assembly may be comprised of a plurality of lenses. The lens assembly may be mounted as close as two millimeters or may be mounted a plurality of feet, from the movable surface. The light source may comprise one or more light emitting diodes. The motion evaluation unit may be adapted to send a signal based on its evaluation of the motion data obtained from the image processing unit. That signal may be adapted to actuate circuitry that effects the movement of the movable surface. The overall system may be powered by a battery self contained in the system or by an external power supply.

### BRIEF DESCRIPTION OF THE DRAWINGS

FIG. 1 is a schematic flow chart illustrating the functional operation of an optical motion sensor.

FIG. 2 is a high-level flow chart illustrating the operation of the sensor in detecting motion of a surface.

FIG. 3 is a perspective view of a motion sensor as described herein.

FIG. 4 is a perspective view of the motion sensor shown in FIG. 3 mounted in a conveyor belt system.

### DETAILED DESCRIPTION

An optical motion sensor as described herein does not require contact with a surface of motion that is the object of the sensor. The sensor does not require a separate lighting source, so it is described as single ended. And the sensor does not require any special treatment of the surface of motion that is being sensed. Accordingly, the optical sensor is a non-contacting, single-ended, and targetless device. The device is comprised of an optical lens system, a light source, an image processing unit and a motion evaluation unit. In one example, this optical system is contained in a single, integral housing. In this way, it may be easily mounted within many industrial applications and operating systems.

Importantly, the present system differs from other displacement sensors in that it does not rely on a motion along the “axis of sensing” in order to detect motion or displacement. On the contrary, the distance from the movable surface being sensed and the fixed sensor remains constant. This may be referred to by describing the sensor as being “perpendicular” to the movable surface even though the sensor is merely stationary versus the movable surface.

Each of the components of this optical system will be discussed in the following. Of course, variations are available and known to those of skill in the art.

The lens system provides an optical magnification of a movable surface relative to the sensor. It is the movable surface that is the object of the sensor. The lens system focuses this image of the movable surface onto an image processing unit. In one alternative, the image processing unit includes photo receptors that will receive the image of the movable surface. The lens system, therefore, provides a means for bringing the image of the movable surface up close to the image processing unit without requiring the image processing component of the sensor to contact the surface of motion.

The lens system may be relatively closer to the movable surface of interest (about 2 mm) or it may be many feet away (for instance 30 feet) depending on the lens system. The lens system may include as few as one lens or may include a plurality of lenses. It is preferable to have the fewest number of lenses possible to accommodate the distance required.

In a specific example of an optical sensor detecting the motion or lack of motion of a conveyor belt, the sensor may contain two lenses that will allow the unit to be operated at a distance of about three to four inches from the surface of motion. In this example, the sensor focuses on a four mm square image at a distance of three to four inches. The specific lenses used to accomplish this level of magnification include a first lens with a focal length of 0.9 mm, and a second lens with a focal length of 8.0 mm. The first and second lenses are 9 mm apart from each other with the second lens closest to the movable surface.

A light source, in one example integral with the housing of the entire optical sensor, is used to provide a defined amount of light at a defined wavelength required by a specific image processing unit in order for that unit to obtain proper images from its photoreceptors. One exemplary light source is a light emitting diode (LED). In one example, the sensor includes a plurality of LEDs integrally contained within the same housing as the other sensor components.

In the alternative of a sensor detecting the motion and lack of motion of a conveyor belt, a unit may contain twelve LEDs, each with a radiometric intensity of 50.5 mWW/sr. This high level of intensity is necessary in order to obtain acceptable images from the dark, mat surface of conveyor belt material. The illumination level may vary depending on the application and may be controlled by feedback information provided by the image processing unit via the motion evaluation unit.

The image processing unit obtains low resolution images of the surface of interest at a high rate. It evaluates those images and converts those images into motion data in order to determine the relative amount and direction of motion.

The process of image capture and analysis may be accomplished in a variety of ways. The image processing unit may include one or more photo-sensing arrays (i.e., photoreceptors) connected to an image processor. The image processing unit could also exist as a single chip as is often found in an optical computer mouse.

In the example of a unit that detects the motion of a conveyor belt, a particular type of acceptable image processing unit includes a chip that is the Agilent ADNS 2051 chip. This particular chip includes photoreceptors and image processing capability.

A motion evaluation unit receives the raw motion data from the image processing unit, filters and smoothes that data, and evaluates it based on programmed options and limits. An example of options would be which directions of motion would be allowed or disallowed for a given application. An example of limits would be minimum and/or maximum values for those directions that are allowed. The motion evaluation unit determines whether motion has occurred by evaluating the motion data from the image processing unit as compared to the specific, programmed options and limits. The motion evaluation unit may then send appropriate control line signals to external devices that actuate or otherwise effect the movement of the movable surface.

In one example, a motion evaluation unit includes as its microcontroller a Motorola MC68HC811E2CFN2 chip. In addition to programmable allowed directions and limits, there could also be switches that allows for selectable variations in those directions and limits as adjustable by a user.

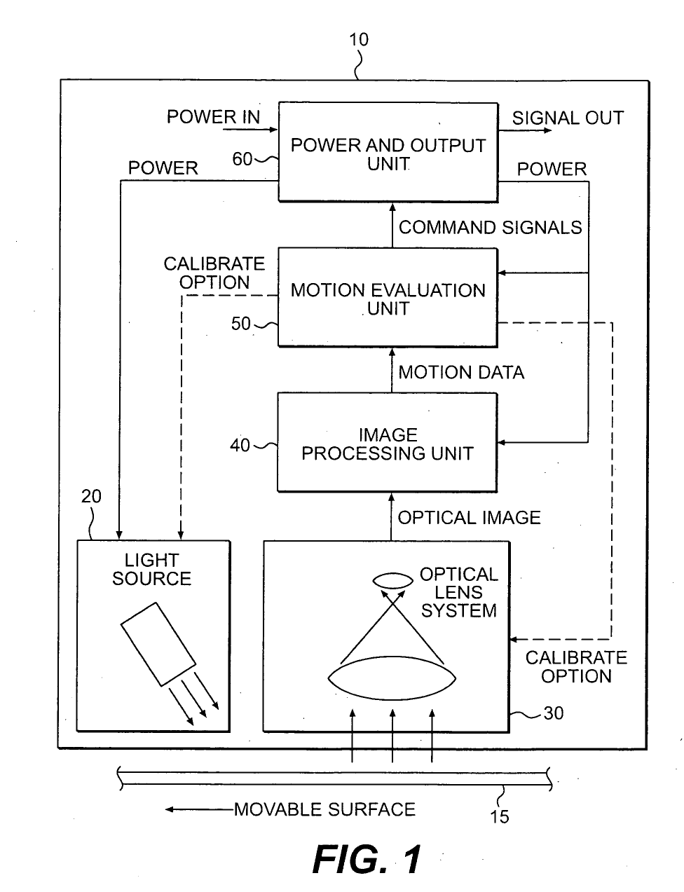

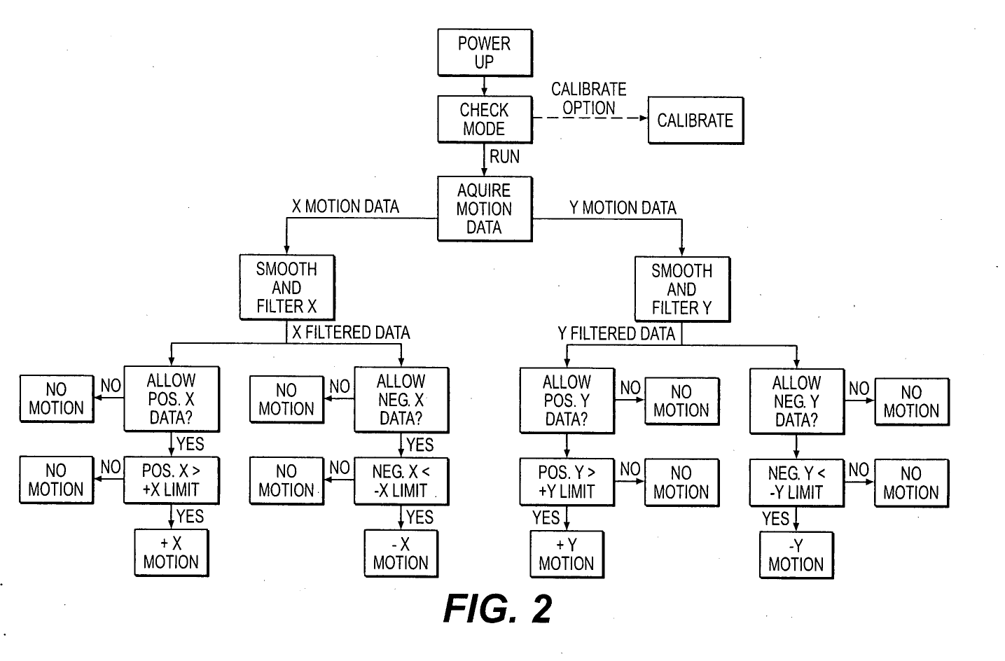

The image processing unit and motion evaluation unit have been discussed above (and are shown in FIGS. 1 and 2) as being two, separate physical components. However, these units may also be considered functionally and incorporated into a single chip. They do not need to be physically separate units. It is only important that a system as described herein perform the functions described.

A power input and output unit provides all the appropriate voltage conversions required by the other components. It also acts as an interface from the motion evaluation unit to external circuitry. External circuitry may include a triac, relay, transistor or other circuitry to activate external devices such as horns, lights, power shut down switches, etc.

As indicated by FIGS. 1 and 2, an optional calibration mode could be added to the sensor to optimize its range and operation. This could be accomplished by adjusting the focus of the lens system and the intensity of the light source. This calibration mode could be initiated at startup, by a command or on a periodic basis.

In the calibration mode, the image processing unit could provide an average illumination level value (or similar relevant parameter) to the motion evaluation unit. This motion evaluation unit, in turn, could vary the light source by means of a command value to vary either the frequency or the voltage level to the light source. The value would be checked again and the process would repeat in this closed loop fashion until a satisfactory value is achieved. The circuitry for varying the light source intensity could reside within the motion evaluation unit or the light source.

The calibration mode could also include a means for focusing the lens system to find the optimum focus. One way to accomplish this is by adding a miniature motor and gear system to the lens system. The motion evaluation unit, using feedback from the image processing unit, could adjust the lens in or out to find the correct focus. In this way, a single sensor could have a broad optical range.

FIG. 1 is a schematic flow chart illustrating the functional operation of an optical motion sensing system as described herein. The optical system 10 detects the motion or lack of motion of the movable surface 15. Light source 20 emits an appropriate intensity and wavelength of light that is reflected off of the movable surface 15 up into the optical lens system 30. The optical image is then detected by the image processing unit 40. The raw motion data is then delivered to the motion evaluation unit 50 that sends signals through the power and output unit 60 to external circuits.

The calibration component is not shown separately in FIG. 1. Rather calibration function is contained in the motion evaluation unit 50, and has the ability to control the light source 20 and lens assembly 30.

FIG. 2 is a high-level flow chart illustrating the operation of the sensor, and specifically the motion evaluation unit 50, in detecting motion of a surface.

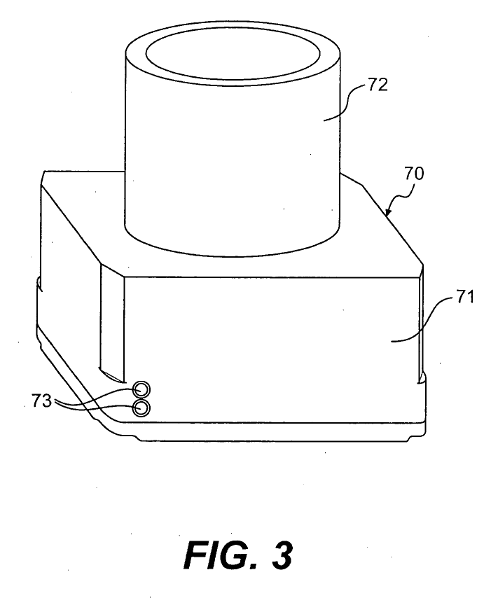

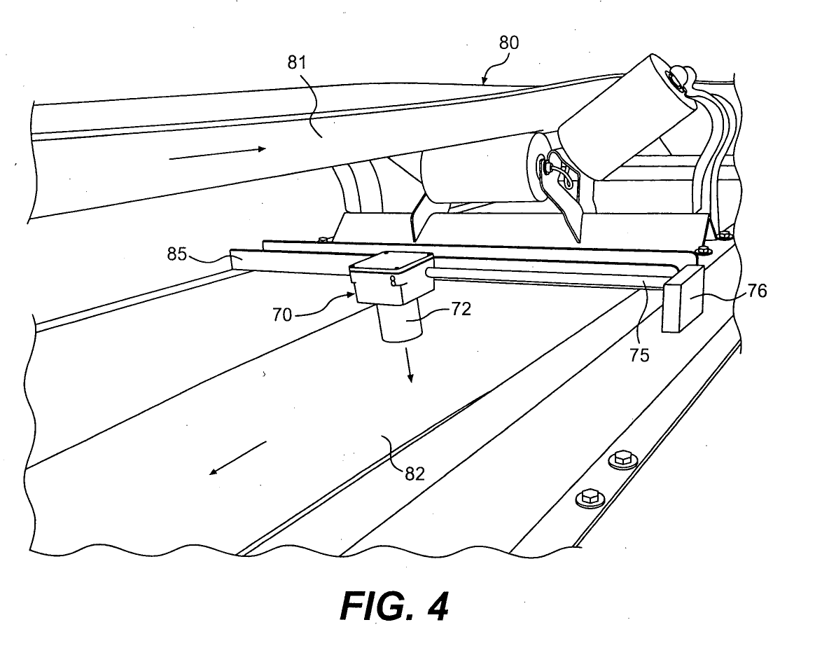

FIGS. 3 and 4 are drawings of an example of an optical system.

FIG. 3 is a perspective view of the sensor 70. The sensor 70 is made up of a housing that includes box 71 and barrel 72. The barrel 72 is a hollow cylinder that protects the lens assembly and light source that are contained within the box 71. The box 71 is simply the container for the light source, lens system, image processing unit, motion evaluation unit, and power and output unit as described earlier in connection with FIG. 1. Power lights 73 indicate the functional state of the sensor.

FIG. 4 illustrates the sensor 70 as it is mounted in a conveyor assembly 80. The conveyor assembly 80 includes a conveyor belt 81, and specifically the return portion of the conveyor belt 82. the sensor is mounted on a frame bar 85 and the barrel 72 is pointing downwardly onto the surface of the belt 82. The sensor 70 is powered by means of a permanent power supply. The sensor 70 is connected by wires through conduit 75 to junction box 76 which will feed to a permanent power source to power the sensor 70. Alternatively, the sensor 70 may include an integral battery and further contain a transmitting device to transmit the signal s that it receives and processes. The sensor 70 is made having the specifications described earlier in this application with respect to the lens assembly, light source, image processing unit, and motion evaluation unit. The sensor 70 is mounted so that the lens system component of the sensor is about four inches from the surface of the belt 82.

Although the invention has been described in detail for the purpose of illustration, it is to be understood and appreciated that such detail is solely for the purpose of example, and that other variations, modifications and applications of the invention can be made by those skilled in the art without departing from the spirit and scope of the invention.

1. An optical system for sensing the motion of a movable surface, the system comprising:
a lens assembly adapted to magnify an image of a movable surface;
a light source;
an image processing unit adapted to obtain images of the movable surface and convert those images into motion data, the image processing unit placed on the opposite side of the lens from the movable surface; and
a motion evaluation unit electronically connected to the image processing unit and adapted to evaluate the motion data obtained from the image processing unit,
wherein the system does not contact the movable surface.

2. An optical system for sensing the motion of a movable surface as described in claim 1, wherein the optical system is mounted within a single, integral housing.

3. An optical system as described in claim 1, wherein the image processing unit comprises photo receptors connected to an image processor.

4. An optical system as described in claim 1, wherein the lens assembly comprises a plurality of lenses.

5. An optical system as described in claim 1, wherein the lens assembly is mounted at least about 2 mm from the movable surface.

6. An optical system as described in claim 1, wherein the lens assembly is mounted at least 3 inches from the movable surface.

7. An optical system as described in claim 1, wherein the light source comprises a light emitting diode.

8. An optical system as described in claim 1, wherein the light source comprises a plurality of light emitting diodes.

9. An optical system as described in claim 1, wherein the motion evaluation unit is further adapted to send a signal based on its evaluation of the images obtained from the image processing unit.

10. An optical system as described in claim 9, wherein the signal is adapted to actuate circuitry that effects the movement of the movable surface.

11. An optical system as described in claim 1, wherein the system is powered by a battery self-contained in the system.

12. An optical system as described in claim 1, wherein the system is powered by an external power supply.

13. An optical system for sensing the motion of a movable surface, the system consisting essentially of:
a lens assembly adapted to magnify an image of a movable surface;
a light source;
an image processing unit adapted to obtain images of the movable surface and convert those images into motion data, the image processing unit placed on the opposite side of the lens from the movable surface; and
a motion evaluation unit electronically connected to the image processing unit and adapted to evaluate the motion data obtained from the image processing unit,
wherein the system does not contact the movable surface.

14. An optical system for sensing the motion of a movable surface as described in claim 13, wherein the optical system is mounted within a single, integral housing.

15. An optical system as described in claim 13, wherein the image processing unit comprises photo receptors connected to an image processor.

16. An optical system as described in claim 13, wherein the lens assembly comprises a plurality of lenses.

17. An optical system as described in claim 13, wherein the lens assembly is mounted at least about 2 mm from the movable surface.

18. An optical system as described in claim 13, wherein the lens assembly is mounted at least 3 inches from the movable surface.

19. An optical system as described in claim 13, wherein the light source comprises a light emitting diode.

20. An optical system as described in claim 13, wherein the light source comprises a plurality of light emitting diodes.

21. An optical system as described in claim 13, wherein the motion evaluation unit is further adapted to send a signal based on its evaluation of the images obtained from the image processing unit.

22. An optical system as described in claim 21, wherein the signal is adapted to actuate circuitry that effects the movement of the movable surface.

23. An optical system as described in claim 13, wherein the system is powered by a battery self-contained in the system.

24. An optical system as described in claim 13, wherein the system is powered by an external power supply.

25. A conveyor assembly comprising:
a conveyor belt mounted onto a support frame, and
a sensor mounted onto the support frame for sensing the motion of the conveyor belt, the sensor comprising:
a lens assembly adapted to magnify an image of the conveyor belt;
a light source;
an image processing unit adapted to obtain images of the surface of the conveyor belt and convert those images into motion data, the image processing unit placed on the opposite side of the lens from the surface of the conveyor belt; and
a motion evaluation unit electronically connected to the image processing unit and adapted to evaluate the motion data obtained from the image processing unit,
wherein the sensor does not contact the surface of the conveyor belt.

26. A conveyor assembly as described in claim 25, wherein the sensor is mounted within a single, integral housing.

27. A conveyor assembly as described in claim 25, wherein the lens assembly is mounted at least 3 inches from the surface of the conveyor belt.

28. A conveyor assembly as described in claim 25, wherein the motion evaluation unit is further adapted to send a signal based on its evaluation of the images obtained from the image processing unit.

29. A conveyor assembly as described in claim 28, wherein the signal is adapted to actuate circuitry that effects the movement of the conveyor belt.
